(19) United States
(12) Patent Application Publication
(10) Pub. No.: US 2008/0116778 A1
(43) Pub. Date: May 22, 2008

(54) Lamp assembley and method for preventing arcing between heat sinks

(76) Inventor: Kevin Hulick, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/601,397

(22) Filed: Nov. 17, 2006

(51) Int. Cl. H01J 7/24; H01J 9/00

(52) U.S. Cl. 313/45; 445/23

(57) ABSTRACT

A lamp assembly for a projector includes first and second heat sinks and a non-electrically-conductive barrier disposed between the first and second heat sinks so as to prevent electrical arcing between the heat sinks. A method of making a lamp assembly includes disposing an electrically insulating barrier between two adjacent heat sinks of the lamp assembly so as to prevent electrical arcing between the heat sinks.

### BACKGROUND

Modern projectors use digital image data to create a high-quality visual display on a viewing surface such as a screen or blank wall. This display can include still images, a series of still images or motion picture video. Projectors are currently used in a wide variety of applications. For example, projectors are used in conference rooms, classrooms and home entertainment systems, in both front and rear projection formats.

Digital projectors utilize high intensity lamps and reflectors to generate the light needed for projection. Light generated by the lamp is concentrated as a ‘fireball’ that is located at the focal point of a reflector. Light produced by the fireball is directed by the reflector into a projection assembly.

The projection assembly produces images from digital image data and utilizes those images to modulate the light beam from the lamp. For example, the projection assembly may include a spatial light modulator such as a digital micro-mirror device (DMD) or liquid crystal display (LCD). The modulated light beam, bearing the desired image, is then projected onto a viewing surface.

Efforts have been directed at making projectors more compact while also making the projected image of higher quality. As a result, the lamps utilized have become more compact and of higher intensity.

An example of one type of such high-intensity lamp is a xenon lamp. Xenon lamps provide significantly more output than some other types of lamps without using substantial amounts of environmentally harmful materials, such as mercury. In addition, xenon lamps have the ability to hot strike and subsequently turn on at near full power.

### SUMMARY

A lamp assembly for a projector includes first and second heat sinks and an electrically non-conductive barrier disposed between the first and second heat sinks so as to prevent electrical arcing between the heat sinks. A method of making a lamp assembly includes disposing an electrically insulating barrier between two adjacent heat sinks of the lamp assembly so as to prevent electrical arcing between the heat sinks.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a cross section of an exemplary lamp assembly for a projector.

FIG. 2 is a cross section of an exemplary lamp assembly for a projector with a non-conductive barrier between adjacent heat sinks according to principles described herein.

FIG. 3 is cutaway view of an exemplary lamp assembly for a projector with a non-conductive barrier between adjacent heat sinks according to principles described herein.

FIG. 4 is a flowchart illustrating a method of making a lamp assembly according to principles described herein.

Throughout the drawings, identical reference numbers designate similar, but not necessarily identical, elements.

### DETAILED DESCRIPTION

The present specification describes devices and methods for managing the heat produced by a high-intensity lamp in a projection system using an electrically non-conductive barrier between adjacent heat sinks. The non-conductive barrier enables the lamp to be made more compact, decreasing the spacing between adjacent heat sinks, without increasing the danger of electrical arcing between the adjacent heat sinks.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

Some embodiments of the principles described herein include a xenon lamp for a projection system. However, it will be appreciated by those skill in the art that the principles disclosed herein may be applied to other types of lamps.

Xenon lamps are arc lamps that include an anode and a cathode. The anode and cathode are precisely positioned relatively to one another such that a gap is established between them. The application of a voltage differential to the electrodes causes electrons to arc across the gap between the electrodes in the presence of the pressurized xenon gas. This arcing generates a bright light with a relatively constant spectral output across the visible light spectrum.

In addition to generating light, the xenon lamp also produces heat. For example, a xenon lamp operating on 330 watts (W) of input power often produces about 25 W of visible light. The remaining power generates infrared radiation (37 W) and ultraviolet radiation (3 W) or is consumed by electrical losses. As a result, the lamp needs to dissipate about 265 W of power, in the form of heat, through conduction, convection, and radiation.

If this heat is allowed to accumulate in the lamp, it may shorten the useful life of the lamp, for example, through accelerated wearing of the electrodes. Additionally, as the heat raises the temperature of the xenon lamp, the pressure of the gas within the xenon lamp is also raised. Consequently, the lamp can suddenly fail if that pressure and/or temperature inside the gas envelope exceed the tolerances of the lamp assembly.

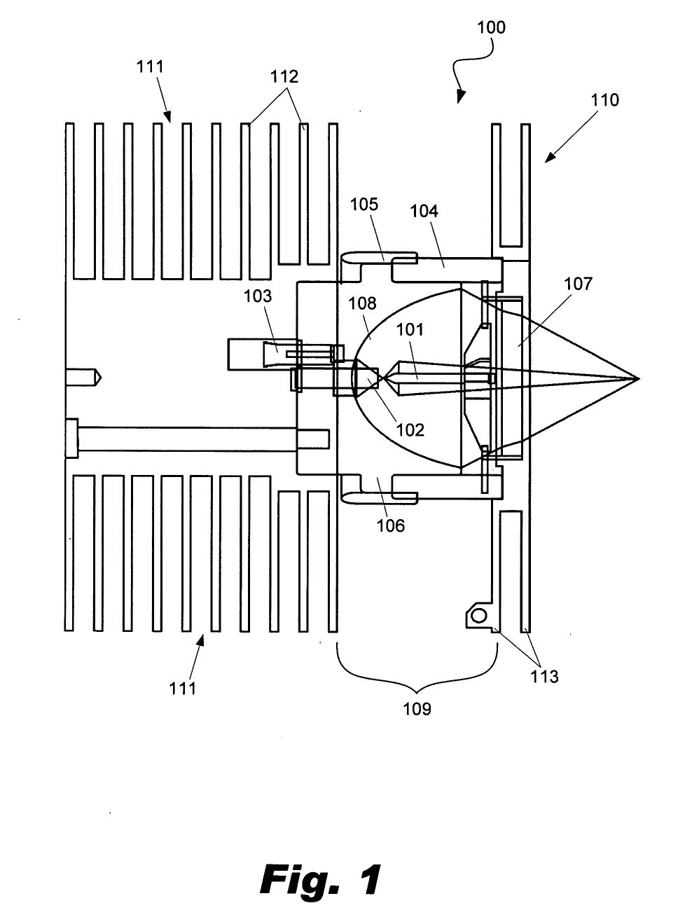

Some designs attempt to dissipate the heat of the lamp with heat sinks. FIG. 1 is a cross sectional view of an exemplary lamp assembly (100) for a projector in which heat is dissipated using two separate heat sinks that correspond to the electrodes of the lamp. The lamp illustrated in FIG. 1 is an arc lamp, for example, a xenon lamp. However, it will be appreciated by those skilled in the art that the principles disclosed herein can be applied to other lamps and lamp assemblies other than a xenon lamp or xenon lamp assembly.

As shown in FIG. 1, a cathode (101) and an anode (102) are carefully positioned with a gap there between. As noted above, the gap is filled with a pressurized gas, such as xenon, through a fill tube (103). When a high enough voltage is applied across the cathode (101) and the anode (102), electrical arcing will occur in the gap between the anode (102) to the cathode (101) producing the desired light.

The cathode (101) and anode (102) are positioned such that the arcing and the consequent generation of light occur at the focus of a reflector (108). The light is then focused by the reflector (108) and directed out of the lamp assembly (100) through, for example, a sapphire window (107).

A forward portion of the reflector (108) is wrapped in a ceramic cylinder (104). The rear potion of the reflector (108) is formed in the reflector body (106), which could be made, for example, of a metal or ceramic. A body sleeve (105) surrounds portions of both the ceramic cylinder (104) and the reflector body (106). Those of skill in the art will appreciate that this is merely one exemplary configuration and that there are many different variations possible in the design of a lamp assembly. The principles described herein, while described in connection with this particular example, are nevertheless independent of the lamp assembly configuration and can be readily adapted to work with all variations.

To dissipate the heat generated by the lamp, the lamp assembly (100) includes two separate heat sinks (110 and 111). Both sinks (110, 111) include a number of fins (112, 113). Heat generated by the operation of the lamp conducts through the heat sinks (110) to these fins (112, 113). Because the fins (112, 113) provide a relatively large surface area, the heat is readily absorbed by the heat sinks (110, 111) and can then readily convect into the ambient environment from the fins (112, 113). Typically, a fan (not shown) will create an air current across the fins (112, 113) to remove the heat and cool the fins (112, 113) during operation of the lamp assembly (100).

As shown in FIG. 1, one heat sink (110) is associated with the cathode (101) and disposed on a forward portion of the lamp assembly (100). The other heat sink (111 ) is associated with the anode (102) and is, consequently, disposed on a rear portion of the lamp assembly (100). In this context, “associated” may including an electrical connection between a heat sink and corresponding electrode.

Given the high voltages used by the lamp across the electrodes (101, 102), there is a risk of electrical arcing between the heat sinks (110, 111). Clearly, such arcing can prevent the intended arc from crossing between the electrodes and producing the desired light for projection. Arcing between the heat sinks (1101, 111) can also damage the lamp assembly or the projection system in which the lamp assembly is used. Consequently, electrical arcing between the heat sinks (110, 111) is to be avoided.

One method of preventing arcing between the heat sinks (110, 111) is simply to separate the sinks (110, 111) with an air gap distance (109) that is sufficient to limit any arcing that might occur. In the example of FIG. 1, the distance (109) is, for example, about 0.5 inches.

Whether arcing is likely to occur between the heat sinks (110, 111) depends on a number of ambient environmental conditions that may vary with time or depend on the location where the lamp assembly is used. For example, altitude, humidity and temperature will all affect the tendency of arcing between the heat sinks (110, 111). Consequently, the spacing (109) between the heat sinks (110, 111) may be maximized to account for any such conditions, even though a particular lamp assembly (100) may never experience those conditions most favorable to electrical arcing between the heat sinks (110, 111). This increases the size of the lamp assembly (100) due to the spacing (109) needed between the heat sinks (110, 111).

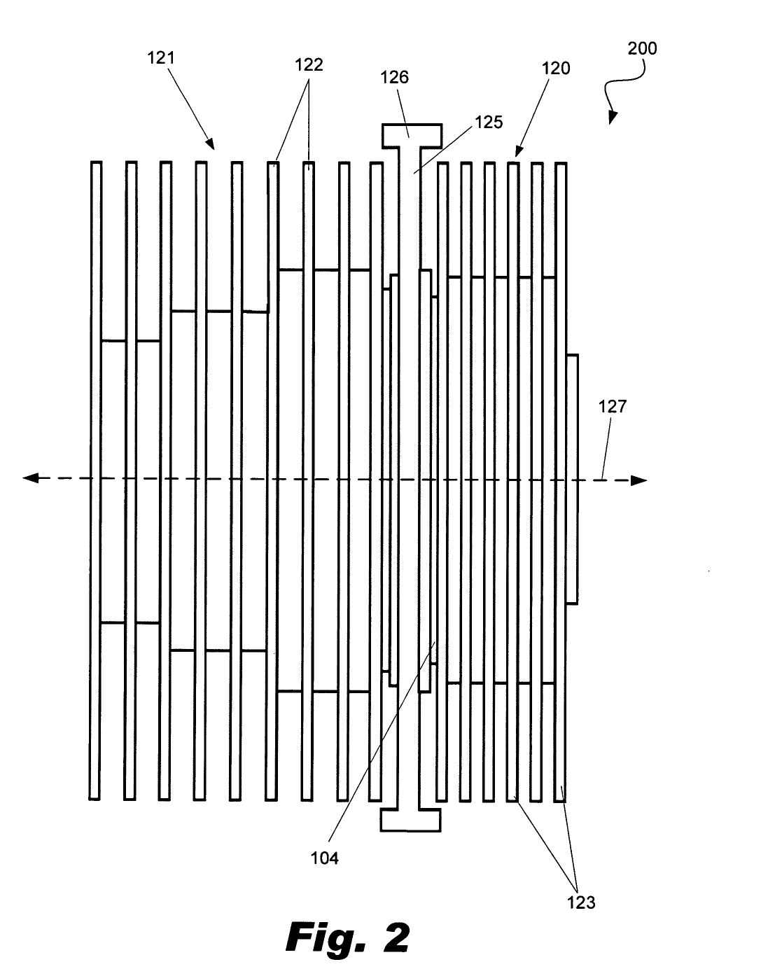

FIG. 2 is a cross section of an exemplary lamp assembly (200) for a projector with an electrically non-conductive barrier between adjacent heat sinks according to principles described herein. As shown in FIG. 2, the lamp assembly (200) again includes two heat sinks (120, 121). As before, each heat sink (120,121) includes a number of fins (122, 123) that are used to dissipate the heat produced by the operation of the lamp. These fins (122, 123) may have a round shape when viewed along the optical axis (127) of the lamp assembly (200) and thus wrap around the lamp. However, the fins (122, 123) may have any of a variety of shapes.

In the example of FIG. 2, the fins (122, 123) are arranged so as to block, impede or restrict air flow along the optical axis (127). However, the spacing between adjacent fins (122,123) permits air flow across or perpendicular to the optical axis (127).

The two heat sinks (122, 123) are thermally, electrically and/or physically separate from each other. As before, each of the heat sinks (122, 123) is respectively associated with an electrode (e.g., an anode or cathode) of the lamp.

As shown in FIG. 2, the heat sinks (122, 123) are spaced relatively close together as compared to the configuration shown in FIG. 1. In the example of FIG. 2, the possibility of electrical arcing between the two heat sinks (122,123) is addressed by providing a barrier of electrically non-conductive or insulating material (125) between the two heat sinks (122, 123).

This barrier (125) may be made of any material that will resist the high temperatures of the lamp assembly (200) and remain electrically insulating or non-conductive so as to prevent electrical arcing between the two heat sinks (122, 123). In the example of FIG. 2, the barrier (125) is placed on the ceramic cylinder (104) of the lamp assembly (200). The ceramic provides insulation for the barrier (125).

The barrier (125) is bonded to the ceramic cylinder (104) using a high temperature, electrically insulating adhesive. The adhesive between the barrier (125) and the ceramic cylinder (104) does not necessarily need to be a high strength adhesive so along as the adhesive can tolerate the operating temperatures of the lamp assembly (200) and remain non-conductive and electrically insulating.

The barrier (125) completely surrounds or encircles the lamp assembly (200), wrapping around the lamp assembly (200), as do the fins (122, 123) of the heat sinks (120, 121). The barrier (125) also extends from the lamp assembly further than do the fins (122, 123) to preclude electrical arcing between the heat sinks (120, 121).

As shown in FIG. 2, the outer edge of the barrier (125) may, in some embodiments, include a cross-member or “T-shaped” portion (126). This cross-member (126) forms an annulus that surrounds the lamp assembly (200) on the periphery of the barrier (125). The cross-member will further serve to electrically isolate the two heat sinks (120, 121) and preclude electrical arcing between the heat sinks (120, 121).

In some embodiments, the barrier (125) may be formed as part of a lamp enclosure, rather than being bonded to the ceramic cylinder (104) of the lamp assembly (200). In such configurations, the barrier (125) is positioned between the heat sinks (120, 121) when the lamp assembly (200) is placed in the lamp enclosure.

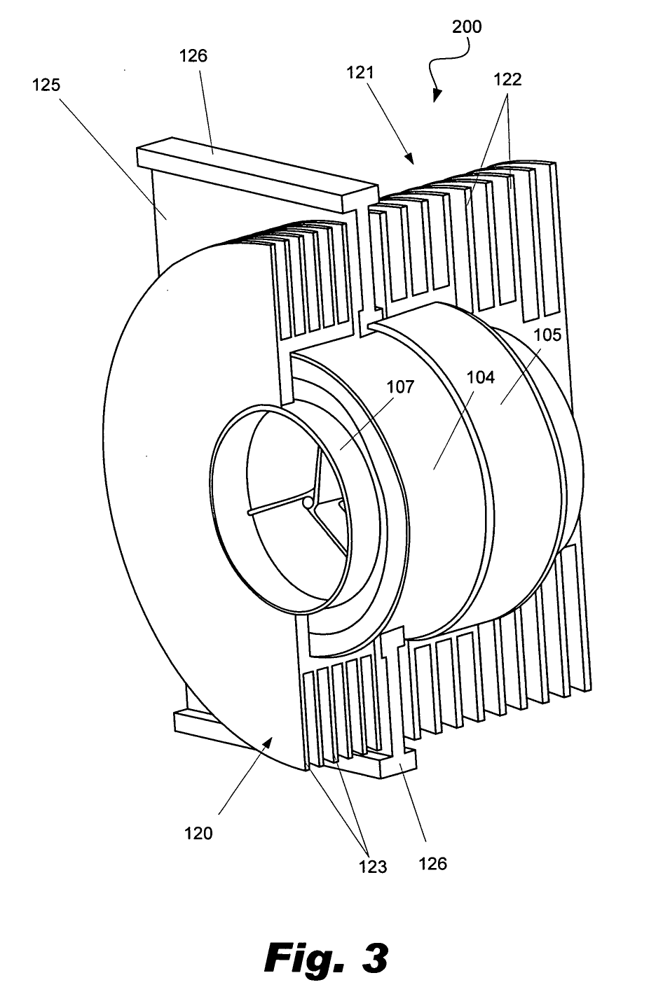

FIG. 3 is cutaway view of the exemplary lamp assembly for a projector with an electrically non-conductive barrier between adjacent heat sinks according to principles described herein. As shown in FIG. 3, the lamp assembly (200) includes two separate heat sinks (120, 121), each including a number of fins (122, 123) that are used to dissipate the heat produced by operation of the lamp. As best seen in FIG. 3, these fins (122, 123) may have a round or circular shape, like a disk, when viewed along the optical axis of the lamp assembly (200). Consequently, the fins (122, 123) wrap around the lamp assembly (200). The two heat sinks (122, 123) are thermally and electrically separate from each other. As before, each of the heat sinks (122, 123) is respectively associated with an electrode (e.g., an anode or cathode) of the lamp.

As before, the heat sinks (122, 123) are spaced relatively close together as compared to the configuration shown in FIG. 1. However, the barrier of electrically non-conductive or insulating material (125) between the two heat sinks (122, 123) addresses the possibility of electrical arcing between the two heat sinks (122, 123).

As easily seen in FIG. 3, the barrier (125) may be placed on the ceramic cylinder (104) of the lamp assembly (200) in some embodiments. As noted above, the barrier (125) is bonded to the ceramic cylinder (104) using a high temperature, electrically insulating adhesive.

As best seen in FIG. 3, the barrier (125) completely surrounds the lamp assembly (200), wrapping around the lamp assembly (200) as do the fins (122, 123) of the heat sinks (120, 121). The barrier (125) also extends from the lamp assembly further than do the fins (122, 123) to preclude electrical aching between the heat sinks (120, 121).

In the example described above, the barrier (125) had a rounded shape with an annular cross-member (126). However, in other embodiments, as shown in FIG. 3, the barrier (25) may have a rectangular shape with the cross-member (126) running in a line across the body of the lamp assembly (200).

The barrier (125) described herein provides a number of advantages in addition to preventing electrical arcing between the heat sinks (120, 121). For example, the fins (122, 123) of the heat sinks (120, 121) can be extended (as shown in FIG. 3) to encircle the lamp assembly (200) without raising concerns of arcing between the heat sinks (120, 121). This provides better cooling of the components of the lamp assembly (200), for example, the ceramic cylinder (104). This also increases the surface area of the fins (122, 123) thereby providing more efficient cooling for the entire lamp assembly (200).

The barrier (125) also enables the heat sinks to be smaller in size or placed closer together without raising concerns of arcing between the heat sinks (120, 121). This, in turn, allows the entirely lamp assembly (200) to be made more compact.

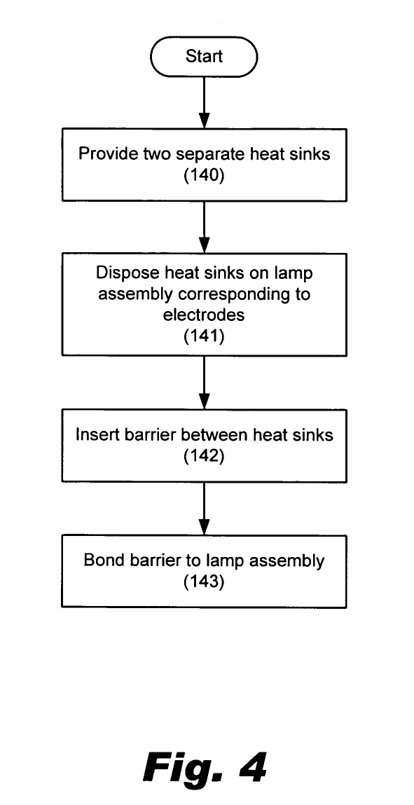

FIG. 4 is a flowchart illustrating a method of making a lamp assembly according to principles described herein. As shown in FIG. 4, the method includes providing two separate heat sinks (step 140). These heat sinks can be formed as separate units or may be integrally formed with the reflector assembly or other components of the lamp assembly.

Next, the heat sinks are disposed on the lamp assembly (step 141). In the case of an arc lamp, the heat sinks are disposed on the lamp assembly corresponding respectively to the two electrodes, i.e., the cathode and anode. There are many possible assembly methods under the principles described herein for disposing the two heat sinks on the lamp assembly. For example, two halves of a heat sink can be bonded together and to the lamp. Alternatively, a heat sink can be slid over the lamp and positioned prior to being attached as part of the lamp assembly.

Then, the non-conductive, electrically insulating barrier described above is inserted between the two heat sinks (step 142). As noted above, the barrier may be in any of a number of different shapes or configurations so as to prevent electrical arcing between the heat sinks.

The barrier is then bonded to the lamp assembly (step 143). As noted above, the barrier may be bonded to the ceramic cylinder (104) using a high temperature, electrically insulating adhesive. The adhesive between the barrier and the ceramic cylinder does not necessarily need to be a high strength adhesive as along as the adhesive can tolerate the operating temperatures of the lamp assembly while remaining non-conductive and electrically insulating. Additionally, the barrier can be attached to the lamp assembly in any of a number of ways that include, for example, but are not limited to, bonding, mechanical fastening and thermoforming or shrink fitting. Also, if an adhesive is used, the adhesive can be any adhesive that prevents arcing between or under the barrier and ceramic spacer or body.

The principles described herein, including the barrier between adjacent heat sinks, provide a number of advantages. For example, the configurations described and illustrated herein allow the heat sinks and the barrier to be wrapped around the body of the lamp, making the lamp safer in the event of a non-passive failure. A further benefit with the wrapped heat sinks is the increased contact area between the lamp and the heat sink, which makes heat removal more efficient. Additionally, the barrier blocks the flow of air in the light emitting direction or along the optical axis of the lamp, but allows for cooling air flow perpendicular to the optical axis. This direction of cooling air flow works more efficiently with many current projection system configurations.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A lamp assembly for a projection system comprising:
first and second heat sinks; and
an electrically non-conductive barrier disposed between said first and second heat sinks so as to prevent electrical arcing between said heat sinks.

2. The lamp assembly of claim 1, wherein a lamp of said lamp assembly is an arc lamp comprising a least one cathode and at least one anode, wherein said first heat sink is associated with said cathode and said second heat sink is associated with said anode.

3. The lamp assembly of claim 2, wherein said lamp is a xenon lamp.

4. The lamp assembly of claim 1, wherein said first and second heat sinks comprise fins that are arranged to impede air flow along an optical axis of said lamp assembly while allowing air flow across an optical axis of said lamp assembly.

5. The lamp assembly of claim 4, wherein said barrier extends between adjacent end fins of said first and second heat sinks.

6. The lamp assembly of claim 1, wherein said barrier extends beyond fins of said first and second heat sinks to electrically isolate said first heat sink from said second heat sink

7. The lamp assembly of claim 1, wherein said barrier comprises a cross-member along an end thereof to further electrically isolate said first heat sink from said second heat sink.

8. The lamp assembly of claim 7, wherein said cross-member surrounds said lamp assembly.

9. The lamp assembly of claim 1, wherein said barrier encircles said lamp assembly.

10. The lamp assembly of claim 1, further comprising:
a lamp; and
a ceramic cylinder around said lamp,
wherein said barrier is bonded to said ceramic cylinder.

11. A lamp assembly for a projector comprising:
first and second heat sinks;
means disposed between said first and second heat sinks for preventing electrical arcing between said heat sinks, wherein said means are electrically insulating.

12. The lamp assembly of claim 11, wherein a lamp of said lamp assembly is an arc lamp comprising a cathode and an anode, wherein said first heat sink is associated with said cathode and said second heat sink is associated with said anode.

13. The lamp assembly of claim 12, wherein said lamp is a xenon lamp.

14. The lamp assembly of claim 11, wherein said first and second heat sinks comprise fins with a disk shape that extend from and surround said lamp assembly.

15. The lamp assembly of claim 14, wherein said means extend between end fins of said first and second heat sinks.

16. The lamp assembly of claim 11, wherein said means comprise a cross-member along an end thereof to further electrically isolate said first heat sink from said second heat sink.

17. The lamp assembly of claim 11, wherein said means encircle said lamp assembly.

18. A method of making a lamp assembly comprising disposing an electrically insulating barrier between two adjacent heat sinks of said lamp assembly so as to prevent electrical arcing between said heat sinks.

19. The method of claim 18, further comprising providing a cross-member along an edge of said barrier to further electrically isolate said first and second heat sinks.

20. The method of claim 18, wherein said insulating barrier encircles said lamp assembly.
